(19) United States
(12) Patent Application Publication
(10) Pub. No.: US 2020/0265233 A1
(43) Pub. Date: Aug. 20, 2020

(54) METHOD FOR RECOGNIZING OBJECT AND ELECTRONIC DEVICE SUPPORTING THE SAME

(71) Applicant: Samsung Electronics Co., Ltd., Gyeonggi-do (KR)

(72) Inventors: Seunghwan JEONG, Gyeonggi-do (KR); Jaeyong YANG, Gyeonggi-do (KR); Dasom LEE, Gyeonggi-do (KR); Saemee YIM, Gyeonggi-do (KR)

(21) Appl. No.: 16/793,133

(22) Filed: Feb. 18, 2020

(30) Foreign Application Priority Data
Feb. 19, 2019 (KR) 10-2019-0019390

(51) Int. Cl. G06K 9/00; G06T 7/60; G06T 11/60

(52) U.S. Cl. CPC G06K 9/00671; G06T 11/60; G06T 7/60

(57) ABSTRACT

An electronic device and method are disclosed. The electronic device includes a camera, display, memory and processor. The processor implements the method, including recognizing an object included in an image captured using the camera or previously stored in the memory, identifying an attribute associated with the recognized object, identifying a matching item, from among the list, that has a first attribute matching the identified attribute by a prespecified similarity threshold, and associating information for the identified matching item with the captured image and display the associated information on the display.

### CROSS-REFERENCE TO RELATED APPLICATION(S)

This application is based on and claims priority under 35 U.S.C. § 119 to Korean Patent Application No. 10-2019-0019390, filed on Feb. 19, 2019, in the Korean Intellectual Property Office, the disclosure of which is incorporated by reference herein its entirety.

### BACKGROUND

### 1. Field

The disclosure relates to a method of recognizing an object through an image to provide information associated with the recognized object and an electronic device supporting the same.

### 2. Description of Related Art

Electronic devices have advanced sufficiently that even portable devices are now capable of recognizing objects that match with images captured through a camera, or pre-stored in memory. For example, an electronic device may launch an application (e.g., Bixby vision, Google Lens, or Naver Smart Lens) to operate a camera and display a preview screen through a display. The electronic device may recognize an object included in an image captured by the camera, using algorithmic recognition operations executed by the device or an external server. The electronic device may display information (e.g., brand name/model name/related product) corresponding to the recognized object on the preview screen in real time.

The above information is presented as background information only to assist with an understanding of the disclosure. No determination has been made, and no assertion is made, as to whether any of the above might be applicable as prior art with regard to the disclosure.

### SUMMARY

Electronic and online retail applications and web portals provide users with numerous functions to improve the shopping experience, such as the ability to favorite products, register an interest in products (e.g., save-for-later, wish-lists, etc.), add products to shopping carts, etc., all of which enable a user to more easily manage their purchases and purchase-interests. The products registered in favorites, “save for later” lists and shopping carts are typically managed individually according to each retailer, and are not associated with widespread object-recognition-enabled applications (e.g., Bixby vision, Google Lens, or Naver Smart Lens).

When an object is algorithmically recognized through the use of stored image data, the electronic device may provide information for the recognized object, and/or provide recommendations of other products related to the recognized product. However, when a product is already present in one of the user's stored product lists (e.g., a wish list), the user may not be aware of this fact. An inconvenience is produced in that the user must identify the product's inclusion in their stored product list separately.

Aspects of the disclosure are to address at least the above-mentioned problems and/or disadvantages and to provide at least the advantages described below.

In accordance with an aspect of the disclosure, an electronic device may include a camera, a display, a memory storing instructions and a list, the list including one or more items designated by a user, a processor, operatively coupled to the camera, the display and the memory, wherein instructions are executable by the processor to cause the electronic device to: recognize an object included in an image captured using the camera or previously stored in the memory, identify an attribute associated with the recognized object, identify a matching item, from among the list, that has a first attribute matching the identified attribute by a prespecified similarity threshold, and associate information for the identified matching item with the captured image and display the associated information on the display.

In accordance with an aspect of this disclosure, a method for an electronic device, the method including: storing a list including at least one or more items designated by a user in a memory of the electronic device, recognizing an object included in an image captured using a camera or previously the memory, identifying an attribute associated with the recognized object, identifying a matching item, from among the list, that has a first attribute matching the identified attribute by a prespecified similarity threshold, and associating information for the identified matching item with the captured image and displaying the associated information on a display.

Other aspects, advantages, and salient features of the disclosure will become apparent to those skilled in the art from the following detailed description, which, taken in conjunction with the annexed drawings, discloses certain embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment, according to certain embodiments;

FIG. 2 is a program configuration diagram of a processor recognizing an object and displaying an interest list, according to certain embodiments;

FIG. 3 is a flowchart illustrating an object recognizing method, according to certain embodiments;

FIG. 4 illustrates a display example view of an item included in an interest list, according to certain embodiments;

FIG. 5 is a flowchart illustrating an operation in a shopping mode of an object recognition application, according to certain embodiments;

FIG. 6 is a flowchart illustrating an operation in a book recognition mode of an object recognition application, according to certain embodiments;

FIG. 7 is a flowchart illustrating an operation in a wine recognition mode of an object recognition application, according to certain embodiments;

FIG. 8A is a flowchart illustrating an operation in a virtual makeup experience mode of an object recognition application, according to certain embodiments;

FIG. 8B illustrates a screen example view in a virtual makeup experience mode of an object recognition application, according to certain embodiments;

FIG. 9A is a flowchart illustrating an operation in a virtual makeup experience mode for a plurality of feature parts of an object recognition application, according to certain embodiments;

FIG. 9B is a screen example view illustrating an operation in a virtual makeup experience mode for a plurality of feature parts of an object recognition application, according to certain embodiments;

FIG. 10 is a flowchart illustrating an operation in a home appliance and furniture virtual placement experience mode of an object recognition application, according to certain embodiments;

FIG. 11 is a flowchart illustrating an operation in an accessory virtual experience mode of an object recognition application, according to certain embodiments;

FIG. 12 is a flowchart illustrating an operation in a place recognition mode of an object recognition application, according to certain embodiments;

FIG. 13 is a flowchart illustrating storage of a user preference, according to certain embodiments; and

FIG. 14 illustrates graph generation for user preference analysis, according to certain embodiments.

### DETAILED DESCRIPTION

Hereinafter, certain embodiments of the disclosure may be described with reference to accompanying drawings. Accordingly, those of ordinary skill in the art will recognize that modification, equivalent, and/or alternative on the certain embodiments described herein can be variously made without departing from the disclosure. With regard to description of drawings, similar elements may be marked by similar reference numerals.

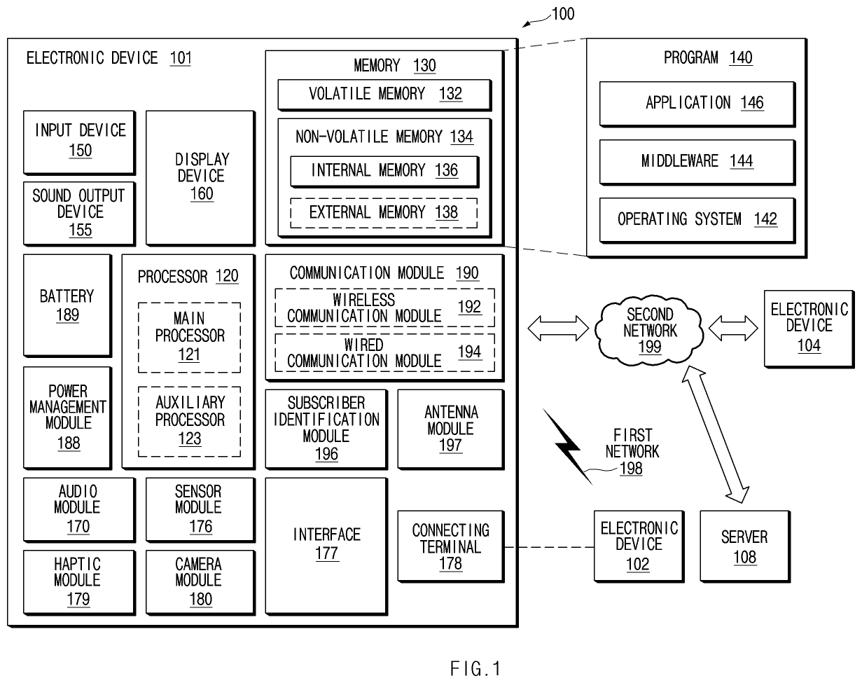

FIG. 1 is a block diagram of an electronic device 101 in a network environment 100 according to certain embodiments. Referring to FIG. 1, the electronic device 101 may communicate with an electronic device 102 through a first network 198 (e.g., a short-range wireless communication network) or may communicate with an electronic device 104 or a server 108 through a second network 199 (e.g., a long-distance wireless communication network) in a network environment 100. According to an embodiment, the electronic device 101 may communicate with the electronic device 104 through the server 108. According to an embodiment, the electronic device 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module 196, or an antenna module 197. According to some embodiments, at least one (e.g., the display device 160 or the camera module 180) among components of the electronic device 101 may be omitted or one or more other components may be added to the electronic device 101. According to some embodiments, some of the above components may be implemented with one integrated circuit. For example, the sensor module 176 (e.g., a fingerprint sensor, an iris sensor, or an illuminance sensor) may be embedded in the display device 160 (e.g., a display).

The processor 120 may execute, for example, software (e.g., a program 140) to control at least one of other components (e.g., a hardware or software component) of the electronic device 101 connected to the processor 120 and may process or compute a variety of data. According to an embodiment, as a part of data processing or operation, the processor 120 may load a command set or data, which is received from other components (e.g., the sensor module 176 or the communication module 190), into a volatile memory 132, may process the command or data loaded into the volatile memory 132, and may store result data into a nonvolatile memory 134. According to an embodiment, the processor 120 may include a main processor 121 (e.g., a central processing unit or an application processor) and an auxiliary processor 123 (e.g., a graphic processing device, an image signal processor, a sensor hub processor, or a communication processor), which operates independently from the main processor 121 or with the main processor 121. Additionally or alternatively, the auxiliary processor 123 may use less power than the main processor 121, or is specified to a designated function. The auxiliary processor 123 may be implemented separately from the main processor 121 or as a part thereof.

The auxiliary processor 123 may control, for example, at least some of functions or states associated with at least one component (e.g., the display device 160, the sensor module 176, or the communication module 190) among the components of the electronic device 101 instead of the main processor 121 while the main processor 121 is in an inactive (e.g., sleep) state or together with the main processor 121 while the main processor 121 is in an active (e.g., an application execution) state. According to an embodiment, the auxiliary processor 123 (e.g., the image signal processor or the communication processor) may be implemented as a part of another component (e.g., the camera module 180 or the communication module 190) that is functionally related to the auxiliary processor 123.

The memory 130 may store a variety of data used by at least one component (e.g., the processor 120 or the sensor module 176) of the electronic device 101. For example, data may include software (e.g., the program 140) and input data or output data with respect to commands associated with the software. The memory 130 may include the volatile memory 132 or the nonvolatile memory 134.

The program 140 may be stored in the memory 130 as software and may include, for example, a kernel 142, a middleware 144, or an application 146.

The input device 150 may receive a command or data, which is used for a component (e.g., the processor 120) of the electronic device 101, from an outside (e.g., a user) of the electronic device 101. The input device 150 may include, for example, a microphone, a mouse, a keyboard, or a digital pen (e.g., a stylus pen).

The sound output device 155 may output a sound signal to the outside of the electronic device 101. The sound output device 155 may include, for example, a speaker or a receiver. The speaker may be used for general purposes, such as multimedia play or recordings play, and the receiver may be used for receiving calls. According to an embodiment, the receiver and the speaker may be either integrally or separately implemented.

The display device 160 may visually provide information to the outside (e.g., the user) of the electronic device 101. For example, the display device 160 may include a display, a hologram device, or a projector and a control circuit for controlling a corresponding device. According to an embodiment, the display device 160 may include a touch circuitry configured to sense the touch or a sensor circuit (e.g., a pressure sensor) for measuring an intensity of pressure on the touch.

The audio module 170 may convert a sound and an electrical signal in dual directions. According to an embodiment, the audio module 170 may obtain the sound through the input device 150 or may output the sound through the sound output device 155 or an external electronic device (e.g., the electronic device 102 (e.g., a speaker or a headphone)) directly or wirelessly connected to the electronic device 101.

The sensor module 176 may generate an electrical signal or a data value corresponding to an operating state (e.g., power or temperature) inside or an environmental state (e.g., a user state) outside the electronic device 101. According to an embodiment, the sensor module 176 may include, for example, a gesture sensor, a gyro sensor, a barometric pressure sensor, a magnetic sensor, an acceleration sensor, a grip sensor, a proximity sensor, a color sensor, an infrared sensor, a biometric sensor, a temperature sensor, a humidity sensor, or an illuminance sensor.

The interface 177 may support one or more designated protocols to allow the electronic device 101 to connect directly or wirelessly to the external electronic device (e.g., the electronic device 102). According to an embodiment, the interface 177 may include, for example, an HDMI (high-definition multimedia interface), a USB (universal serial bus) interface, an SD card interface, or an audio interface.

A connecting terminal 178 may include a connector that physically connects the electronic device 101 to the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal to a mechanical stimulation (e.g., vibration or movement) or an electrical stimulation perceived by the user through tactile or kinesthetic sensations. According to an embodiment, the haptic module 179 may include, for example, a motor, a piezoelectric element, or an electric stimulator.

The camera module 180 may shoot a still image or a video image. According to an embodiment, the camera module 180 may include, for example, at least one or more lenses, image sensors, image signal processors, or flashes.

The power management module 188 may manage power supplied to the electronic device 101. According to an embodiment, the power management module 188 may be implemented as at least a part of a power management integrated circuit (PMIC).

The battery 189 may supply power to at least one component of the electronic device 101. According to an embodiment, the battery 189 may include, for example, a non-rechargeable (primary) battery, a rechargeable (secondary) battery, or a fuel cell.

The communication module 190 may establish a direct (e.g., wired) or wireless communication channel between the electronic device 101 and the external electronic device (e.g., the electronic device 102, the electronic device 104, or the server 108) and support communication execution through the established communication channel. The communication module 190 may include at least one communication processor operating independently from the processor 120 (e.g., the application processor) and supporting the direct (e.g., wired) communication or the wireless communication. According to an embodiment, the communication module 190 may include a wireless communication module (or a wireless communication circuit) 192 (e.g., a cellular communication module, a short-range wireless communication module, or a GNSS (global navigation satellite system) communication module) or a wired communication module 194 (e.g., an LAN (local area network) communication module or a power line communication module). The corresponding communication module among the above communication modules may communicate with the external electronic device through the first network 198 (e.g., the short-range communication network such as a Bluetooth, a Wi-Fi direct, or an IrDA (infrared data association)) or the second network 199 (e.g., the long-distance wireless communication network such as a cellular network, an internet, or a computer network (e.g., LAN or WAN)). The above-mentioned various communication modules may be implemented into one component (e.g., a single chip) or into separate components (e.g., chips), respectively. The wireless communication module 192 may identify and authenticate the electronic device 101 using user information (e.g., international mobile subscriber identity (IMSI)) stored in the subscriber identification module 196 in the communication network, such as the first network 198 or the second network 199.

The antenna module 197 may transmit or receive a signal or power to or from the outside (e.g., an external electronic device). According to an embodiment, the antenna module may include one antenna including a radiator made of a conductor or conductive pattern formed on a substrate (e.g., a PCB). According to an embodiment, the antenna module 197 may include a plurality of antennas. In this case, for example, the communication module 190 may select one antenna suitable for a communication method used in the communication network such as the first network 198 or the second network 199 from the plurality of antennas. The signal or power may be transmitted or received between the communication module 190 and the external electronic device through the selected one antenna. According to some embodiments, in addition to the radiator, other parts (e.g., a RFIC) may be further formed as a portion of the antenna module 197.

At least some components among the components may be connected to each other through a communication method (e.g., a bus, a GPIO (general purpose input and output), an SPI (serial peripheral interface), or an MIPI (mobile industry processor interface)) used between peripheral devices to exchange signals (e.g., a command or data) with each other.

According to an embodiment, the command or data may be transmitted or received between the electronic device 101 and the external electronic device 104 through the server 108 connected to the second network 199. Each of the electronic devices 102 and 104 may be the same or different types as or from the electronic device 101. According to an embodiment, all or some of the operations performed by the electronic device 101 may be performed by one or more external electronic devices among the external electronic devices 102, 104, or 108. For example, when the electronic device 101 performs some functions or services automatically or by request from a user or another device, the electronic device 101 may request one or more external electronic devices to perform at least some of the functions related to the functions or services, in addition to or instead of performing the functions or services by itself. The one or more external electronic devices receiving the request may carry out at least a part of the requested function or service or the additional function or service associated with the request and transmit the execution result to the electronic device 101. The electronic device 101 may provide the result as is or after additional processing as at least a part of the response to the request. To this end, for example, a cloud computing, distributed computing, or client-server computing technology may be used.

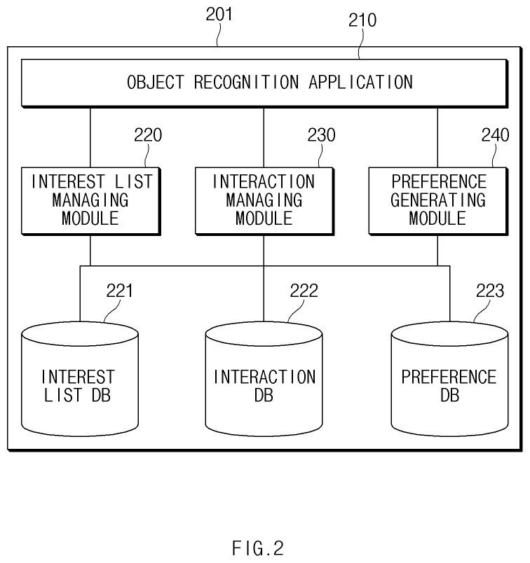

FIG. 2 is a program configuration diagram of a processor recognizing an object and displaying an interest list, according to certain embodiments. FIG. 2 is, but is not limited to, an example.

Referring to FIG. 2, a program 201 may include an object recognition application 210, an interest list managing module 220, an interaction managing module 230, a preference generating module 240, an interest list DB 221, an interaction DB 222, and a preference DB 223.

According to an embodiment, the object recognition application 210 (e.g., Bixby vision, Google Lens, or Naver Smart Lens) may collect image data using the camera module 180 and may recognize the object included in the collected image data. The object recognition application 210 may display information about the recognized object. For example, when a sneaker is included in a preview image using the camera module 180, the object recognition application 210 may recognize the sneaker through image processing and may display the brand name, model number, and price of the sneaker in a region overlapping with the sneaker or in a region adjacent to the sneaker.

According to certain embodiments, the object recognition application 210 (e.g., Bixby vision, Google Lens, or Naver Smart Lens) may recognize the object included in the image stored in an internal memory or downloaded from an external server. The object recognition application 210 may display information about the recognized object. For example, the object recognition application 210 may recognize the object in the gallery image stored in the internal memory and may display information about the recognized object. For another example, the object recognition application 210 may recognize an object in an image included in an Internet web page and may display information about the recognized object.

According to another embodiment, the object recognition application 210 may be an application that performs a product search, using a text. For example, the object recognition application 210 may be a shopping mall website such as Samsung Pay Shopping or Amazon Shopping.

The interest list managing module 220 may store and manage a list (hereinafter, referred to as an “interest list”) (or a wish list) including at least one item, in which a specified user is determined to have an interest, in the interest list DB 221. The interest list may be a list including items such as things, goods, food, or places in which a specified user registered in electronic device 101 (e.g., a smartphone or wearable device) is determined to have an interest.

The interest list managing module 220 may store and manage items, in which the user is determined to have an interest under a specified condition, in the interest list DB 221. In an embodiment, the condition may include at least one of a condition (e.g., occurring a user input to add or delete an item to or from the interest list) by the input of a user, a condition (e.g., searching for a product or buying a product, the specified number of times or more) by the specified interaction occurring in the electronic device 101, or a condition (e.g., updating the interest list stored in a server) provided by an external device (e.g., server).

According to an embodiment, when the user adds an item to the interest list or deletes an item from the interest list, the interest list managing module 220 may update the interest list. The interest list managing module 220 may match an item having an attribute the same as or similar to that of the recognized object and then may provide the matched result to the object recognition application 210.

The interaction managing module 230 may collect information according to the interaction performed by the user from the object recognition application 210 and may store the information in the interaction DB 222. For example, when the user browses product information according to the found result, stores the product information in the interest list, or purchases a product based on the product information, the product information may be linked with the interaction of the user, and then the linked result may be stored in the interaction DB 222. For another example, when a user places products through augmented reality (AR) or generates an input to fit clothes, the product information is matched with a user input, and then the matched result may be stored in the interaction DB 222.

The user preference generating module 240 may determine the preference for each attribute of an item included in the interest list, based on the collected interaction data of the user. The user preference generating module 240 may store the preference for the user's product in the preference DB 223. For example, when the number of searches, views, or purchases of a product is great, the user preference generating module 240 may highly set the preference for the attribute of the product.

According to certain embodiments, the user preference generating module 240 may score and manage the preference based on the user interaction for each item in the preference DB 223.

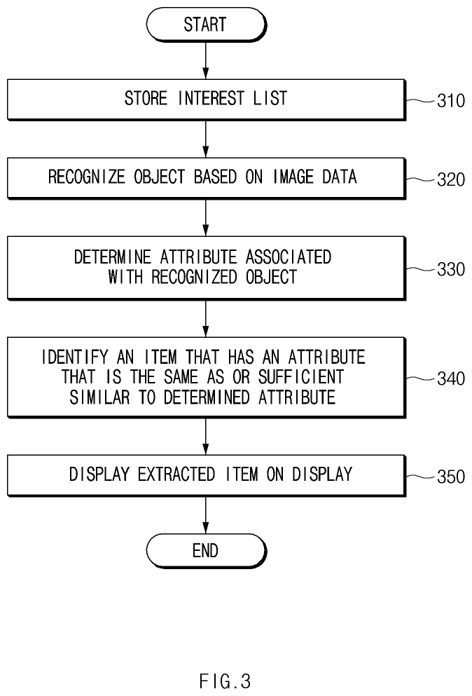

According to certain embodiments, the preference DB 223 may be updated based on event data from other apps. For example, a preference weight in the preference DB 223 may be updated based on the wish list of Samsung Pay Shopping. For another example, the preference weight in the preference DB 223 may be updated by the records of a text search word in a web browser app. For still another example, the preference DB 223 may be updated by the utterance record of a voice command app (e.g., Bixby Voice). FIG. 3 is a flowchart illustrating an object recognizing method, according to certain embodiments.

Referring to FIG. 3, in operation 310, the processor 120 of the electronic device 101 (e.g., a smartphone or wearable device) may store a user's interest list. The interest list may be stored responsive to a specified user input, or upon request by the specified application. The interest list may include items such products, places, foods and other objects in which the user is determined to have an interest. According to an embodiment, the interest list may be managed through the object recognition application 210 (e.g., Bixby vision, Google Lens, or Naver Smart Lens).

According to certain embodiments, when the object recognition application (e.g., Bixby vision, Google Lens, or Naver Smart Lens) is executed and then an object is recognized, the processor 120 may display a user interface (e.g., a heart icon) for adding the recognized object to the interest list. The icon may be displayed together with information about the recognized object. When a separate user input occurs in the icon, the processor 120 may add the recognized object to the interest list.

According to certain embodiments, the processor 120 may classify recognized objects depending on an attribute and then may three-dimensionally store the classified result through a database. Each item included in the interest list may have at least one or more attributes. For example, the item may have a category attribute (e.g., first classification (clothing)/second classification (top)/third classification (brand)), time attribute (e.g., the time included in the interest list), or location attribute (e.g., the place included in the interest list)).

According to certain embodiments, the item may have a preference attribute. The preference attribute may be updated based on information the same as information such as the search frequency, the number of additions of related products, and the number of payments. For example, whenever an item is added to the interest list, the processor 120 may store and manage an attribute for the item added using a method of a database table query.

According to certain embodiments, the processor 120 may receive a product list managed by another application different from the object recognition application 210, from an external server. The processor 120 may include the received product list in the interest list managed by the object recognition application 210. For example, the processor 120 may receive a list of products in a shopping cart managed by a shopping app (e.g., Amazon or Samsung Pay Shopping) with the specified user's account and then may include the list of products in the interest list managed by the object recognition application 210.

In operation 320, the processor 120 may recognize an object, using image data. The image data may be captured using the camera module 180, or downloaded from the external server and stored in the memory 130. For example, the processor 120 may collect image data by receival from an image sensor included in the camera module 180. For another example, the processor 120 may collect the image data as displayed by a web browser app.

The processor 120 may recognize an object by performing internal operations on the collected image data or by performing algorithmic operations on the collected image data through an external device (e.g., server).

For example, the processor 120 may process the image data depending on a specified algorithm by an internal operation to extract the contour, shape, or feature point of the object. The processor 120 may match the extracted contour, shape, or feature point with information of a database associated with the pre-stored object recognition. The processor 120 may extract information about the name, type, or model name of the matched object.

For another example, the processor 120 may transmit the collected image data to an external server through the communication module 190. The processor 120 may receive information about the object recognized through the image data, from the external server. For example, the processor 120 may receive information about the name, type, or model name of the recognized object.

In operation 330, the processor 120 may determine an attribute (e.g., a matching keyword) that is associated with the recognized object. The processor 120 may determine the attribute of an object through image analysis, or may determine an attribute of an object by extracting category information stored in the object information. Alternatively, the processor 120 may determine the attribute by analyzing the text included in the image.

According to an embodiment, the processor 120 may determine the product classification of the recognized object as an attribute for item matching. For example, when the recognized object is a Nike sneaker, the attribute may be determined as shoes or a sneaker. For another example, when the recognized object is jeans, the attribute may be determined as clothing or pants.

According to another embodiment, the processor 120 may determine the upper category of the recognized object as an attribute for item matching.

For example, when the recognized place is ‘Starbucks Gangnam’, the attribute for item matching may be determined as ‘Starbucks’. For another example, when the recognized place is ‘Starbucks Gangnam’, the attribute for item matching may be determined as ‘cafe’, which is the upper category of ‘Starbucks’.

According to still another embodiment, the processor 120 may determine that the recognized object itself is an attribute for item matching. For example, when the recognized object is a lip in a person's face, the attribute for item matching may be determined as a lip.

In operation 340, the processor 120 may determine whether the item includes an attribute that matches the determined attribute by a threshold degree of similarity or exactitude, from among items included in the interest list.

According to an embodiment, the processor 120 may extract an item having the same attribute as that of the recognized object. For example, when the recognized object is a Nike sneaker, products having a sneaker attribute may be extracted from items included in the interest list.

According to an embodiment, the processor 120 may extract an item having an attribute having a high similarity with the attribute of a recognized object. For example, when the recognized object is a smartphone, products having a smartphone attribute or a tablet PC attribute may be extracted from items included in the interest list.

In operation 350, the processor 120 may display the extracted item on the display. The processor 120 may display the matched item together with information pertaining to the recognized object. For example, when the Nike sneaker is recognized, the processor 120 may display the model name for the Nike sneaker, and may display sneakers included in the interest list, in the adjacent region.

According to certain embodiments, when the item displayed through the specified user input is selected, the processor 120 may display detailed information associated with the selected item. The processor 120 may execute another application (e.g., a shopping app), not the object recognition application, to display the detailed information.

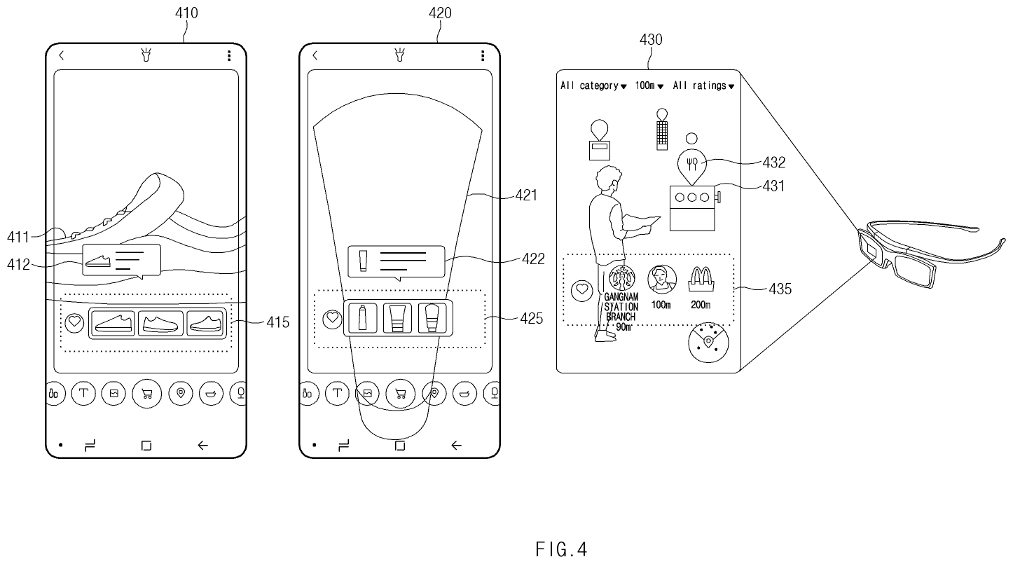

FIG. 4 illustrates a display example view of an item included in an interest list, according to certain embodiments. FIG. 4 is, but is not limited to, an example.

Referring to FIG. 4, the processor 120 of the electronic device 101 (e.g., a smartphone or wearable device) may display image data on a display. The image data may be image data captured using the camera module 180 or image data downloaded from the external server and then stored in the memory 130. For example, when an object recognition application such as Bixby vision, Google Lens, or Naver Smart Lens is executed, the processor 120 may collect the image data through the camera module 180. The processor 120 may output the preview image to a display device (e.g., the display 160) by processing the collected image data. For another example, the processor 120 may display the image stored in a Gallery app, on the display.

According to certain embodiments, the processor 120 may recognize an object, using the image data. The processor 120 may transmit the collected image data to an external server through the communication module 190. The processor 120 may receive recognition information about the recognized object through image data, from the external server. The processor 120 may display the received information on the display.

For example, in first screen 410, the processor 120 may recognize an object 411 included in the image as a “Nike sneaker.” The processor 120 may display recognition information 412 about the recognized object 411 in a region adjacent to the object 411. The processor 120 may determine an image having the highest image similarity with the object 411 and may display the recognition information 412 corresponding to the corresponding image. The recognition information 412 may include information about the image, name, brand, model name, or price of the recognized object 411.

For another example, in second screen 420, the processor 120 may recognize an object 421 included in the image, as a hand cream. The processor 120 may display recognition information 422 about the recognized object 421 in a region adjacent to the object 421. The recognition information 422 may include information about the image, name, model name, brand, product description, or price of the recognized object 421.

For still another example, in third screen 430, the processor 120 may recognize nearby buildings and/or shops as the object(s) 431 included in the image. The processor 120 may display recognition information 432 about the recognized object 431 in a region adjacent to the object 431 (e.g., a restaurant icon). The recognition information 432 may include information about one or more of the image, name, franchise name, branch name, street, menu, or price of the recognized object 431.

According to certain embodiments, the processor 120 may extract an item having an attribute having an attribute, which is the same as the attribute of the recognized object or has the high similarity with the attribute of the recognized object, among items included in a pre-stored interest list. The processor 120 may display the extracted item together with the recognition information 412, 422 or 432 about the object 411, 421 or 431.

For example, in first screen 410, the processor 120 may recognize the object 411 included in the image as a Nike sneaker. The processor 120 may determine the attribute of the object 411 as a sneaker and may extract an item having a sneaker attribute among items stored in the interest list. The processor 120 may display information 415 about the extracted item together with the recognition information 412. The information 415 about the item may include information about the image, name, brand, model name, or price of the item having a sneaker attribute. In the information 415 about the item, the processor 120 may sort items in ascending order of a user preference, with reference to the user's brand preference stored in the preference DB 223.

For another example, in second screen 420, the processor 120 may recognize that the object 421 included in the image is a hand cream. The processor 120 may determine an attribute of the object 421 to be “hand cream” and may extract one or more matching items having a “hand cream” attribute from among the items stored in the interest list. The processor 120 may display the information 425 about the extracted item together with the recognition information 422. The information 425 about the item may include information about the image, name, model name, brand, product description, or price of the item having a hand cream attribute. In the information 425 about the item, the processor 120 may sort items in ascending order of a user preference, with reference to the user's brand preference stored in the preference DB 223.

For still another example, in third screen 430, the processor 120 may recognize an object 431 included in the image as a building or store. The processor 120 may determine the attribute of the object 421, as one of a franchise name (e.g., Starbucks or McDonald) or a category (e.g., Korean restaurant, Italian restaurant, or Chinese restaurant) and may extract an item having the same franchise name or the same category as an attribute among the items stored in the interest list. The processor 120 may display information 435 about the extracted item together with recognition information 432. For example, the information 435 about the item may include information about an image, name, franchise name, branch name, street, menu, or price of a nearby branch of the item having the same franchise name. For another example, the information 435 about the item may include information about the image, name, branch name, street, menu or price of a nearby branch of the item of the same category (e.g., Italian restaurant).

In the information 435 about the item, the processor 120 may sort items in ascending order of a user preference, with reference to the user's franchise preference stored in the preference DB 223.

According to certain embodiments, when there are a plurality of matched items among the items included in the interest list, the processor 120 may sort and display the items in the specified order. The processor 120 may sort the items matched based on the predetermined criterion depending on the preference of the user and the attribute of the item which are analyzed in advance.

According to certain embodiments, when there are a plurality of matched items among the items included in the interest list, the processor 120 may display the item matched based on a lower attribute. For example, when the number of items matched with a sneaker attribute is 10 and the number of items matched with the Nike brand attribute is 5 among the 10 items, five items having the Nike brand attribute may be displayed.

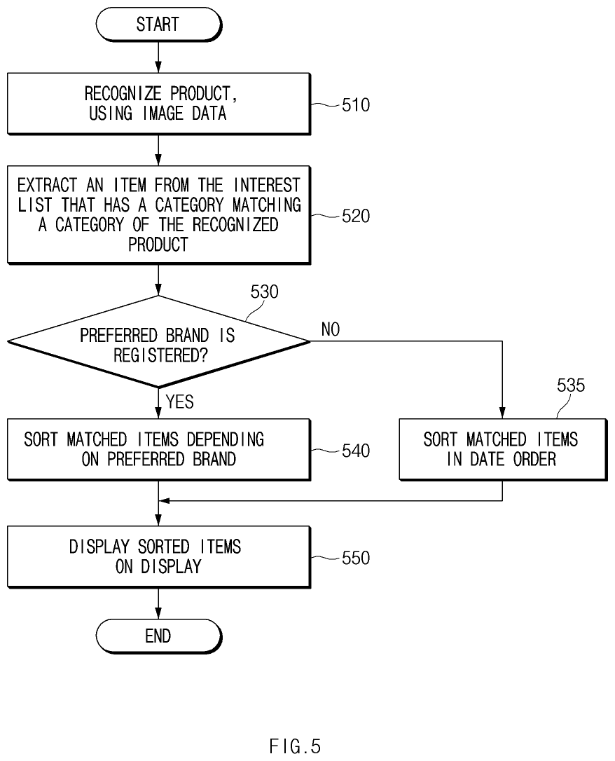

FIG. 5 is a flowchart illustrating an operation in a shopping mode of an object recognition application, according to certain embodiments.

Referring to FIG. 5, in operation 510, the processor 120 may recognize a product that is depicted within image data. The image data may be image captured using the camera module 180, or an image downloaded from the external server and then stored in the memory 130. The processor 120 may recognize the product by extracting contour, shape, or feature point of the object by an internal algorithmic operation or an algorithmic operation using an external server. The processor 120 may extract information about the image, name, brand, model name, or price of an object.

In operation 520, the processor 120 may extract an item included in an interest list that includes a category matching a category of the recognized product. That is, a match from the list may be detected using category information of the recognized product as an attribute (e.g., or a matching keyword). For example, when the recognized object is model “XX” of a Nike sneaker, the processor 120 may extract an item having an attribute of (i.e., belong to a same category as) “sneaker” or “shoes,” among the plurality of items included in the interest list.

According to an embodiment, when there is no matched item, the processor 120 may not perform a separate operation. In this case, information about the recognized product may be displayed, and information associated with the interest list may not be displayed. Alternatively, other products (e.g., the most frequently found products in other shopping malls) of the same category as the recognized object may be displayed.

In operation 530, when multiple matching items are extracted (e.g., detected), the processor 120 may determine whether the preferred brand of the user is set. The preferred brand of the user may be set in advance based on history information such as the search history and purchase history of the user.

In operation 535, when the preferred brand of the user is not set, the processor 120 may sort the matching items according to the date in which they were added to the interest list.

In operation 540, when the preferred brand of the user is set, the processor 120 may sort the matched items according to brand preference. Preferred brands may be given priority over non-preferred brands. Further, when multiple items are associated with the same brand, the processor 120 may sort these items of the same brand according to the dates they were added to the interest list.

According to certain embodiments, the processor 120 may sort items based on not only the preferred brand but also another preference such as a price preference or a new product preference for each attribute.

In operation 550, the processor 120 may display the sorted items on a display.

According to certain embodiments, the processor 120 may make a request for the recommendation product information to an external server, using category information or brand information of the recognized object. The processor 120 may display the recommended item received from an external server together with items of the interest list.

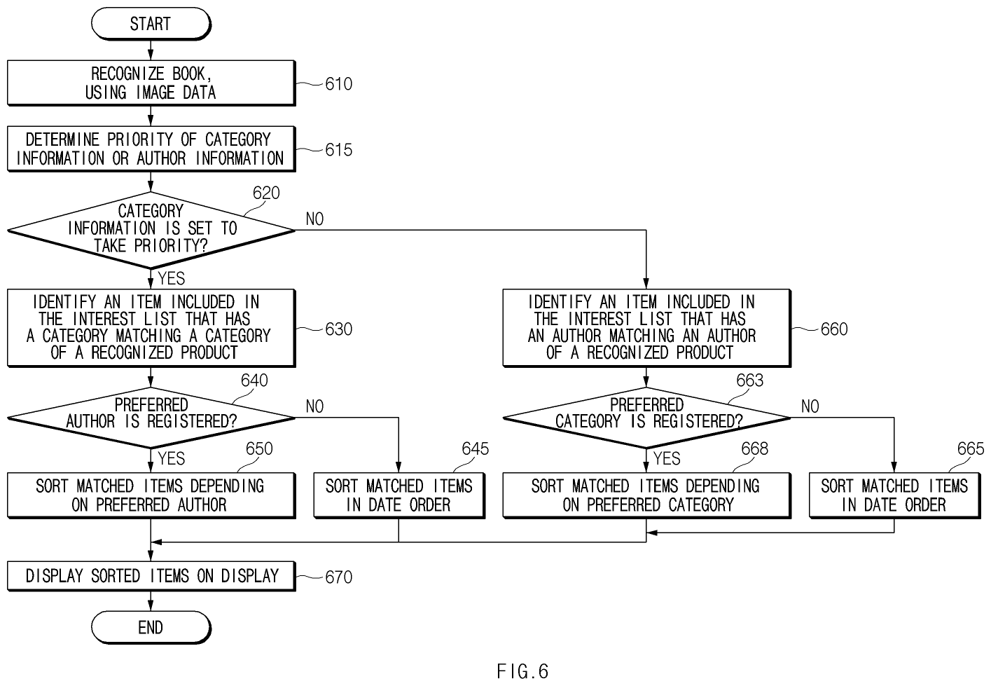

FIG. 6 is a flowchart illustrating an operation in a book recognition mode of an object recognition application, according to certain embodiments.

Referring to FIG. 6, in operation 610, the processor 120 may recognize a book, using image data. The image data may include an image captured using the camera module 180, or an image downloaded from the external server, and then stored in the memory 130. The processor 120 may recognize the book by extracting the text, design, picture, or pattern shown on the cover of the book by an internal algorithmic operation or an algorithmic operation using an external server. The processor 120 may extract information about the book's representative image, name, author, release date, or price.

In operation 615, the processor 120 may determine the priority of category information or author information. That is, for the purposes of sorting information, either the category information or the author information may be preferred over the other. This preference can be set by a default setting or by a user setting.

In operation 620, the processor 120 may determine whether the category information is set to take priority.

In operation 630, when the category information takes priority over the author information, the processor 120 may extract an item included in an interest list having a category that matches a category of the recognized book. Thus, the category information is used as an attribute (or matching keyword). For example, when the recognized book is a novel, the processor 120 may extract an item having “novel” as an attribute from books included in the interest list.

In operation 640, when a matched item is detected, the processor 120 may determine whether the preferred author of the user is set. The preferred author of the user may be set in advance, based on history information such as the search history, and/or purchase history of the user.

In operation 645, when the preferred author of the user is not set, the processor 120 may sort the matched items according to the date they were added to the interest list.

In operation 650, when the preferred author of the user is set, the processor 120 may sort the matched items according to the preferred author. That is, books associated with the preferred author may be prioritized in the arrangement over books that are associated with other authors. Furthermore, the processor 120 may sort the books associated with the same author according to the date they were added to the interest list.

In operation 660, when the author information takes priority over the category information, the processor 120 may extract an item included in the interest list that has an author matching the author information of the recognized book as an attribute (or matching keyword). For example, when the recognized book is Shakespeare's work, the processor 120 may extract an item, for which “Shakespeare” is the author, from books included in the interest list.

In operation 663, when the matched item is present, the processor 120 may determine whether the preferred category of the user is set. The preferred category of the user may be set in advance based on history information such as the search history and purchase history of the user.

In operation 665, when the preferred category of the user is not set, the processor 120 may sort the matched items according to the date they were added to the interest list.

In operation 668, when the preferred category of the user is set, the processor 120 may sort the matched items depending on the preferred category. The processor 120 may sort the books of the same category according to the date they were added to the interest list.

In operation 670, the processor 120 may display the sorted items on a display.

According to certain embodiments, the processor 120 may make a request for recommendation book information or best seller information to an external server, using category information or author information of the recognized object. The processor 120 may display the recommended item received from the external server together with items of the interest list.

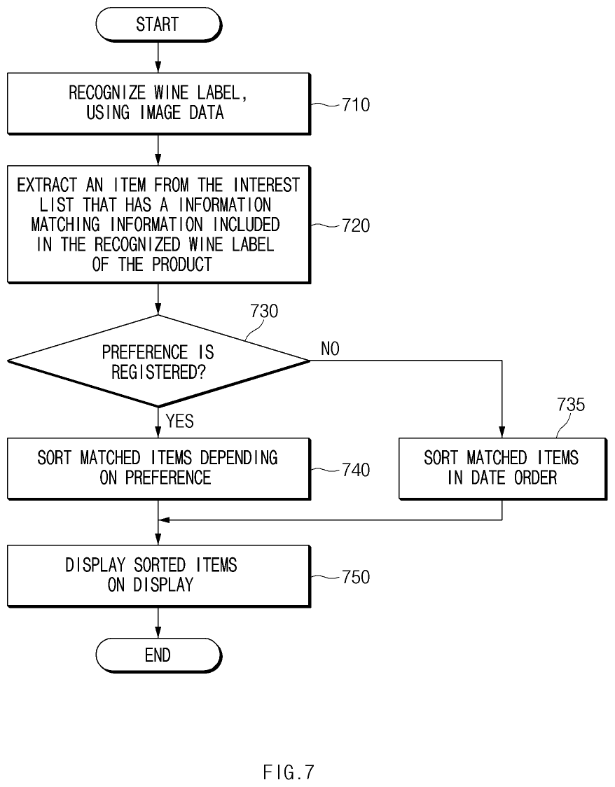

FIG. 7 is a flowchart illustrating an operation in a wine recognition mode of an object recognition application, according to certain embodiments.

Referring to FIG. 7, in operation 710, the processor 120 may recognize a wine label, using image data. The image data may be image data captured using the camera module 180 or image data downloaded from the external server and then stored in the memory 130. The processor 120 may recognize a bottle of wine by extracting the text, design, picture, or pattern included in the wine label by an internal algorithmic operation or an algorithmic operation using an external server. The processor 120 may extract information about the image, name, type, release year, or price of the wine.

In operation 720, the processor 120 may extract an item included in an interest list, using type information of the recognized wine as an attribute (or matching keyword). For example, the processor 120 may match an item, using one of “Red”, “White”, “Sparkling”, “Rose”, “Dessert”, or “Fortified”.

In operation 730, when the matched item is present, the processor 120 may determine whether the user's preference (e.g., a preferred region, a preferred country, or a preferred grape variety) among the wine-related attributes is set. For example, the user's preferred region, preferred country, or preferred grape variety may be set in advance based on history information such as the user's search history and purchase history.

In operation 735, when the user's preference (e.g., a preferred region, a preferred country, or a preferred grape variety) is not set, the processor 120 may sort the matched items according to the date each was added to the interest list.

In operation 740, when the user's preference (e.g., a preferred region, a preferred country, or a preferred grape variety) is set, the processor 120 may sort the matched items depending on the preference (e.g., a preferred region, a preferred country, or a preferred grape variety). The processor 120 may sort the items having the same preference in the date order included in the interest list.

In operation 750, the processor 120 may display the sorted items on a display.

According to certain embodiments, the processor 120 may make a request for the recommendation product information to an external server, using the price information or the rating information of the recognized wine. The processor 120 may display the recommended item received from the external server together with items of the interest list.

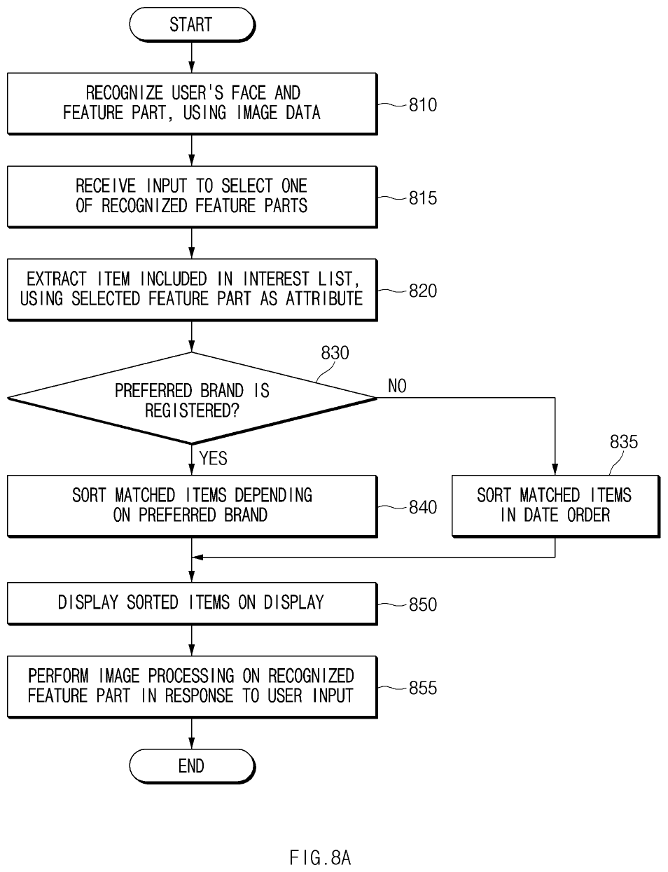

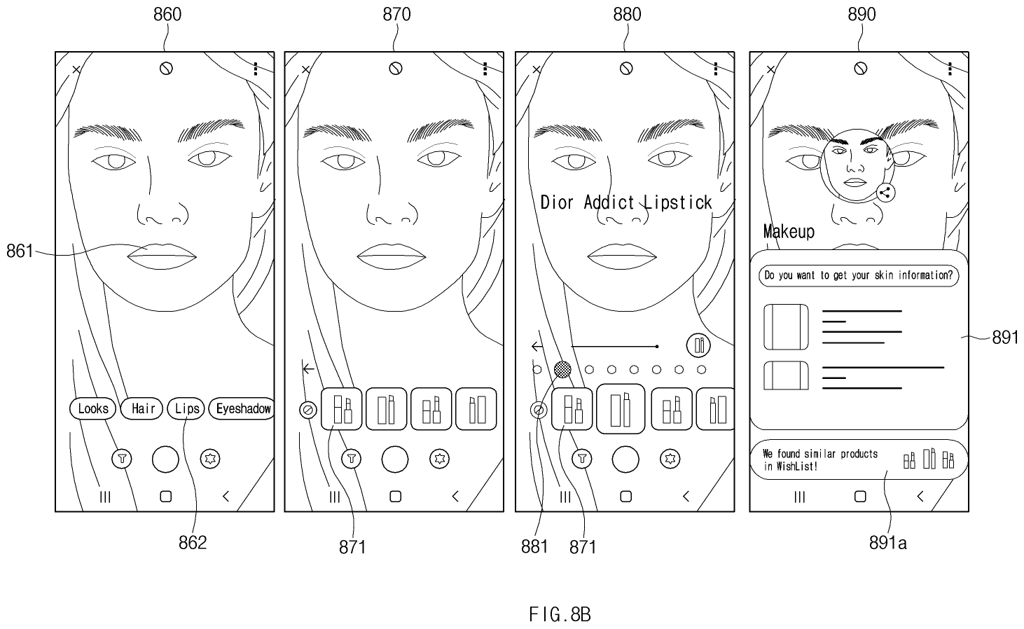

FIG. 8A is a flowchart illustrating an operation in a virtual makeup experience mode of an object recognition application, according to certain embodiments.

Referring to FIG. 8A, in operation 810, the processor 120 may recognize a user's face and a key feature part included in the face as an object, using image data. The image data may be image data captured using the camera module 180 or image data downloaded from the external server and then stored in the memory 130. The processor 120 may recognize the user's face and the key feature part included in the face by extracting the contour, shape, or feature point by an internal algorithmic operation or an algorithmic operation using an external server. For example, the processor 120 may recognize the location and region of a hair, eyebrow, eye, nose, mouth, and cheek.

In operation 815, the processor 120 may receive an input to select one of the recognized feature parts. For example, when the recognized feature part is the eyebrow, eye, nose, mouth, or cheek, the processor 120 may display an icon for each recognized feature part. The processor 120 may determine whether a user input occurs in one of the displayed icons.

In operation 820, the processor 120 may extract an item included in an interest list, using the feature part selected by the user input as an attribute (or matching keyword). For example, when the selected feature part is a lip, the processor 120 may extract an item having an attribute of a lip, among cosmetics included in the interest list.

In operation 830, when the matched item is present, the processor 120 may determine whether the preferred brand of the user is set. The preferred brand of the user may be set in advance based on history information such as the search history and purchase history of the user.

In operation 835, when the preferred brand of the user is not set, the processor 120 may sort the matched items in the date order included in the interest list.

In operation 840, when the preferred brand of the user is set, the processor 120 may sort the matched items depending on the preferred brand. The processor 120 may sort the items of the same brand in the date order included in the interest list.

According to certain embodiments, the processor 120 may sort items for each item attribute in order of color preference, texture preference, and related search words.

In operation 850, the processor 120 may display the sorted items on a display.

According to certain embodiments, the processor 120 may make a request for recommendation product information to an external server, using information about the selected feature part or brand information. The processor 120 may display the recommended item received from the external server together with items of the interest list.

In operation 855, when one of the sorted items is selected by a user input, the processor 120 may perform image processing of the product effect on the recognized feature part, in response to the user input. For example, when Dior lipstick is selected, the color of Dior lipstick may be virtually applied to the recognized lip region and may be displayed.

FIG. 8B illustrates a screen example view in a virtual makeup experience mode of an object recognition application, according to certain embodiments. FIG. 8B is, but is not limited to, an example.

Referring to FIG. 8B, in screen 860, the processor 120 may recognize a user's face and a key feature part 861 included in the face as an object, using image data. The image data may be image data captured using the camera module 180 or image data downloaded from the external server and then stored in the memory 130. For example, the processor 120 may recognize the location and region of an eyebrow, eye, nose, mouth, and cheek. The processor 120 may display a user interface associated with a virtual makeup experience mode. According to an embodiment, a selection icon 862 for each feature part included in the face may be displayed. According to an embodiment, the processor 120 may display the selection icon 862 for the recognized feature part through a process of recognizing an object. The processor 120 may determine whether a user input occurs in one of the displayed icons 862.

In screen 870, the processor 120 may display a preset product list 871 associated with the feature part selected by the user input. According to an embodiment, the processor 120 may sort a product list 871 based on the pre-stored preference of a user.

In screen 880, when one of products in the product list 871 is selected, the processor 120 may display a color icon 881 to select the color to be applied. When the user selects one of the color icon 881, the color selected by the color icon 881 may be exemplarily applied to the corresponding object (e.g., a lip) 861 and may be displayed.

In screen 890, when the selected color is determined by the user input (e.g., when the user presses a touch button to apply a color), the processor 120 may display detailed information (e.g., a representative image, a color name, a brand name, or a price) 891 about the determined product. According to an embodiment, the processor 120 may extract and display the item included in the interest list, using the selected feature part or the selected product as an attribute (or a matching keyword). When the selected feature part is a lip, the processor 120 may extract and display a lipstick or lip-gloss having an attribute of a lip among cosmetics included in the interest list. When the preferred brand of the user is set, the processor 120 may sort and display items 891 depending on the preferred brand.

According to certain embodiments, the processor 120 may make a request for recommendation product information to an external server, using information about the selected feature part or brand information. The processor 120 may display a recommendation item 891a received from an external server together with items of the interest list. According to an embodiment, when an item corresponding to information about the selected feature part or brand information is not included in the interest list, the processor 120 may display the recommendation item 891a.

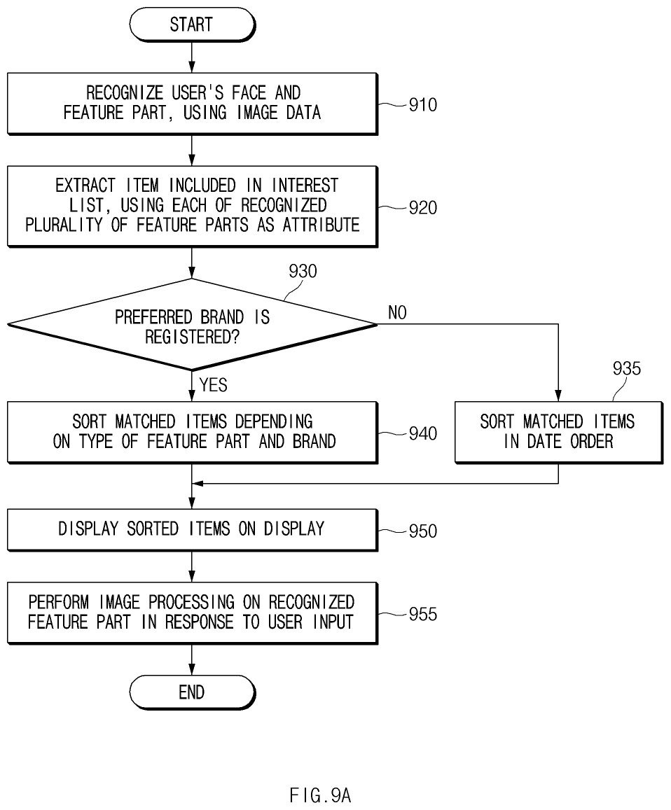

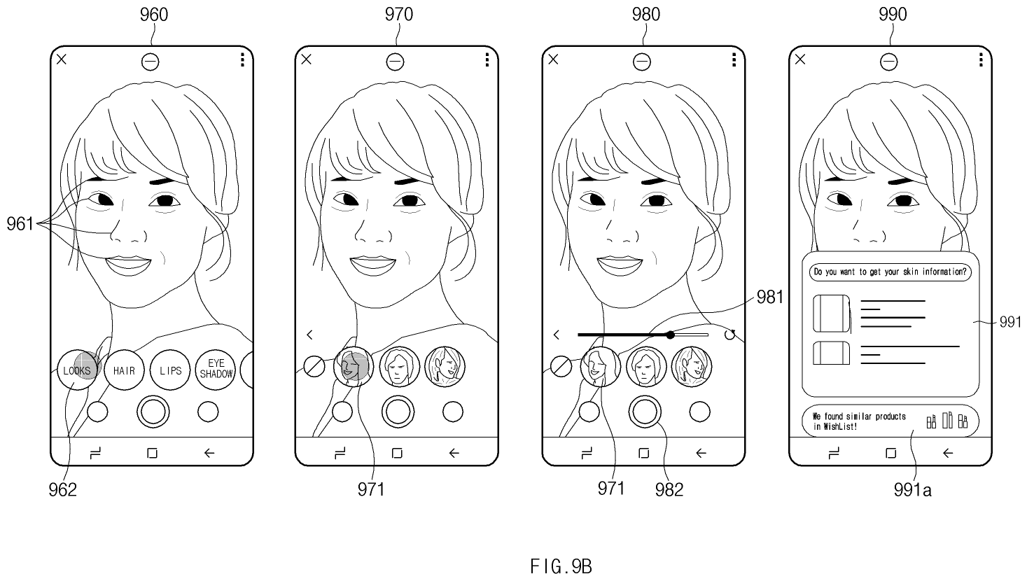

FIG. 9A is a flowchart illustrating an operation in a virtual makeup experience mode for a plurality of feature parts of an object recognition application, according to certain embodiments.

Referring to FIG. 9A, in operation 910, the processor 120 may recognize a user's face and a key feature part included in the face as an object, using image data. The image data may be an image captured using the camera module 180 or an image downloaded from the external server and then stored in the memory 130. The processor 120 may recognize the user's face and a key feature part included in the face, by extracting the contour, shape, or feature point by an internal algorithmic operation or an algorithmic operation using an external server. For example, the processor 120 may recognize the location and region of a hair, eyebrow, eye, nose, mouth, and cheek.

In operation 920, the processor 120 may extract an item included in an interest list that has features matching the recognized feature of the user's face. That, matching may be executed using each of the recognized plurality of feature parts as an attribute (or matching keyword). For example, when the eyebrow, eye, nose, mouth, or cheek is recognized, the processor 120 may extract all items having the attributes of the eyebrow, eye, nose, mouth, and cheek among the cosmetics included in the interest list.

In operation 930, when the matched item is present, the processor 120 may determine whether the preferred brand of the user is set. The preferred brand of the user may be set in advance based on history information such as the search history and purchase history of the user.

In operation 935, when the preferred brand of the user is not set, the processor 120 may sort the matched items according to a date each was added to the interest list.

In operation 940, when the preferred brand of the user is set, the processor 120 may sort the matched items depending on the type of the feature part and the preferred brand.

The processor 120 may sort the items of the same brand according to the dates they were added to the interest list.

In operation 950, the processor 120 may display the sorted items on a display.

According to certain embodiments, the processor 120 may make a request for recommendation product information to an external server, using information about the recognized feature part or brand information. The processor 120 may display the recommended item received from the external server together with items of the interest list.

In operation 955, when one of the sorted items is selected by a user input, the processor 120 may perform image processing of the product effect on the recognized feature part, in response to the user input. For example, when Dior lipstick is selected, the color of Dior lipstick may be virtually applied to the recognized lip region and may be displayed.

FIG. 9B is a screen example view illustrating an operation in a virtual makeup experience mode for a plurality of feature parts of an object recognition application, according to certain embodiments. FIG. 9B is, but is not limited to, an example.

Referring to FIG. 9B, in screen 960, the processor 120 may recognize a user's face and a key feature part 961 included in the face as an object, using image data. For example, the processor 120 may recognize the location and region of the eyebrow, eye, nose, or mouth. The processor 120 may display a user interface associated with a virtual makeup experience mode. The processor 120 may display an icon 962 to select the whole face (e.g., an eyebrow, an eye, a nose, and a mouth). The processor 120 may determine whether a user input occurs in the icon 962.

In screen 970, the processor 120 may display an image 971, to which different makeup styles are applied. When one of the image 971 is selected, the cosmetics applied to the selected image 971 may be applied to the corresponding feature part (e.g., an eyebrow, an eye, a nose, a mouth, or cheek) as an example of virtual makeup.

In screen 980, the processor 120 may display a UI 981 for controlling product application effects. The processor 120 may display a button 982 for displaying detailed information of cosmetics applied to the selected image 971.

In screen 990, when a user input occurs at the button 982, the processor 120 may display detailed information (e.g., a representative image, a color name, a brand name, or a price) 991 of cosmetics applied to the virtual makeup. The processor 120 may extract and display items included in the interest list, using the entire feature parts (e.g., an eyebrow, an eye, a nose, a mouth, and a cheek) as an attribute (or matching keyword).

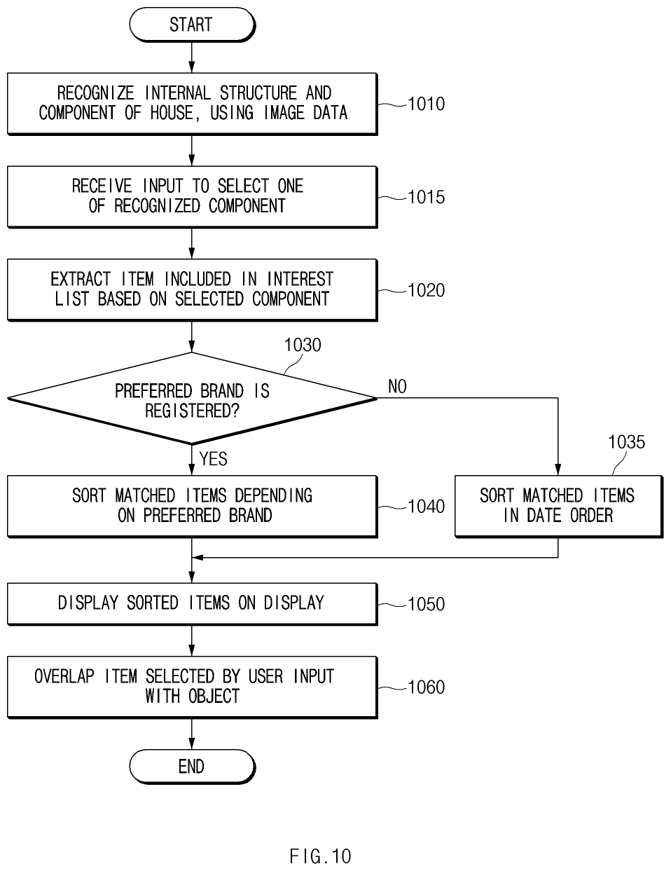

According to certain embodiments, the processor 120 may make a request for recommendation product information to an external server, using information about a feature part (e.g., an eyebrow, an eye, a nose, a mouth, or a cheek) or brand information. The processor 120 may display a recommendation item 991a received from the external server together with items of the interest list. According to an embodiment, when an item corresponding to the information about a feature part (e.g., an eyebrow, an eye, a nose, a mouth, or a cheek) or the brand information is not included in the interest list, the processor 120 may display a recommendation item 991a. FIG. 10 is a flowchart illustrating an operation in a home appliance and furniture virtual placement experience mode of an object recognition application, according to certain embodiments.

Referring to FIG. 10, in operation 1010, the processor 120 may collect image data, using the image data and may recognize the internal structure and component (e.g., furniture or appliances) of the house included in an image as an object. The processor 120 may recognize the internal structure and component by extracting the contour, shape, or feature point by an internal algorithmic operation or an algorithmic operation using an external server. For example, the processor 120 may recognize the shape/area of the wall of a living room and the shape/location of a table/TV/sofa.

In operation 1015, the processor 120 may receive an input to select one of the recognized components. For example, when the table/TV/sofa is recognized, the processor 120 may display an icon for each of the recognized feature parts. The processor 120 may determine whether a user input occurs in one of the displayed icons.

In operation 1020, the processor 120 may extract an item included in an interest list, using the component selected by a user input as an attribute (or matching keyword). For example, when the selected feature part is a TV, the processor 120 may extract an item having the attribute of a TV among home appliances included in the interest list.

In operation 1030, when the matched item is present, the processor 120 may determine whether the preferred brand of the user is set. The preferred brand of the user may be set in advance based on history information such as the search history and purchase history of the user.

In operation 1035, when the preferred brand of the user is not set, the processor 120 may sort the matched items in the date order included in the interest list.

In operation 1040, when the preferred brand of the user is set, the processor 120 may sort the matched items depending on the preferred brand. The processor 120 may sort the items of the same brand in the date order included in the interest list.

In operation 1050, the processor 120 may display the sorted items on a display.

According to certain embodiments, the processor 120 may make a request for recommendation product information to an external server, using information about the selected component or brand information. The processor 120 may display the recommended item received from the external server together with items of the interest list.

In operation 1060, when one of the sorted items is selected by a user input, the processor 120 may overlap the corresponding product with the corresponding component. For example, when Samsung OLED TV is selected, Samsung OLED TV may virtually overlap with the recognized TV region and then may be displayed.

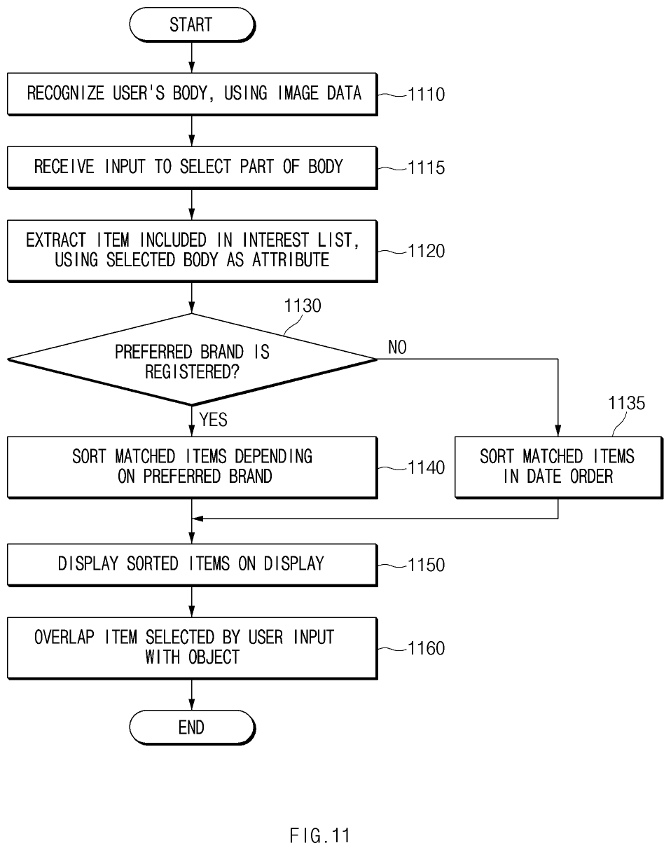

FIG. 11 is a flowchart illustrating an operation in an accessory virtual experience mode of an object recognition application, according to certain embodiments.

Referring to FIG. 11, in operation 1110, the processor 120 may collect image data, using the image data and may recognize a user's body included in the image as an object. The processor 120 may recognize the user's face or the user's body by extracting the contour, shape, or feature point by an internal algorithmic operation or an algorithmic operation using an external server.

In operation 1115, the processor 120 may receive an input to select a part of the user's body. For example, when recognizing the user's face, the processor 120 may display an icon for each feature part (e.g., an eye, a nose, or a mouth) included in the face. The processor 120 may determine whether a user input occurs in one of the displayed icons.

In operation 1120, the processor 120 may extract an item included in an interest list, using the body as an attribute (or matching keyword) in response to a user input. For example, when the selected feature part is an eye, the processor 120 may extract an item having an attribute of glasses, among products included in the interest list.

In operation 1130, when the matched item is present, the processor 120 may determine whether the preferred brand of the user is set. The preferred brand of the user may be set in advance based on history information such as the search history and purchase history of the user.

In operation 1135, when the preferred brand of the user is not set, the processor 120 may sort the matched items in the date order included in the interest list.

In operation 1140, when the preferred brand of the user is set, the processor 120 may sort the matched items depending on the preferred brand. The processor 120 may sort the items of the same brand in the date order included in the interest list.

In operation 1150, the processor 120 may display the sorted items on a display.

According to certain embodiments, the processor 120 may make a request for recommendation product information to an external server, using information about the selected component or brand information. The processor 120 may display a recommendation item received from an external server together with items of the interest list.

In operation 1160, when one of the sorted items is selected by a user input, the processor 120 may apply the product to the corresponding body of the user. For example, when the sunglasses of Gucci are selected, the sunglasses of Gucci may be virtually overlapped with the face of the user and then may be displayed.

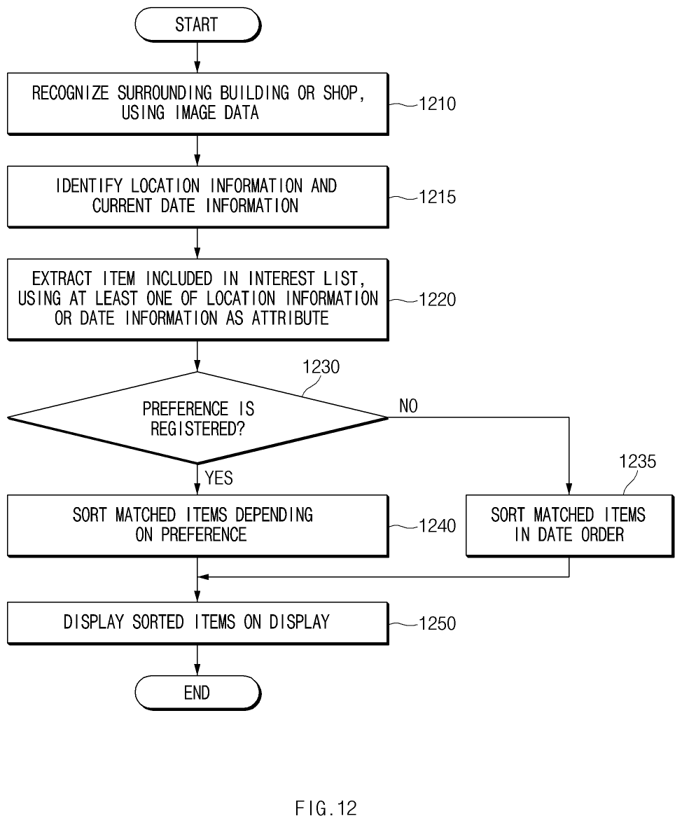

FIG. 12 is a flowchart illustrating an operation in a place recognition mode of an object recognition application, according to certain embodiments.

Referring to FIG. 12, in operation 1210, the processor 120 may collect image data, using the image data and may recognize a surrounding building or shop included in an image as an object. For example, the processor 120 may recognize a building name, a store name, a store type, and a franchise name based on the text, picture, and pattern of the signboard recognized through the location of the electronic device 101, the moving direction of the electronic device 101, and the image.

According to certain embodiments, the processor 120 may display a peripheral interest (POI) based on the location information of the electronic device 101. In operation 1215, the processor 120 may identify location information (e.g., a periphery of a house, a periphery of a company, a frequent visit place, a recent visit place, or a first visit place) and current date information (e.g., a date, a day, or a time) of the electronic device 101.

In operation 1220, the processor 120 may extract an item included in an interest list, using at least one of the location information or the date information as an attribute (or matching keyword). For example, when the current location of the electronic device 101 is ‘Gangnam Station’ and the current date information is a weekend afternoon, a places having ‘Gangnam Station’ or weekend/afternoon as an attribute may be extracted from the interest list.

In operation 1230, when the matched item is present, the processor 120 may determine whether the user's preference (e.g., a preferred place type or a preferred franchise type) associated with a place is set. For example, the user's preference (e.g., a preferred place type or a preferred franchise type) associated with a place may be set in advance based on history information such as the user's search history and purchase history.

In operation 1235, when the user's preference (e.g., a preferred place type or a preferred franchise type) associated with a place is not set, the processor 120 may sort the matched items in the date order included in the interest list.

In operation 1240, when the user's preference (e.g., a preferred place type or a preferred franchise type) associated with a place is set, the processor 120 may sort the matched items depending on the user's preference (e.g., a preferred place type or a preferred franchise type) associated with a place. The processor 120 may sort the items having the same preference in the date order included in the interest list.

In operation 1250, the processor 120 may display the sorted items on a display. The processor 120 may display an item having the same franchise name or information about the image, name, franchise name, branch name, street, menu, or price of a neighboring branch of the same category.

For example, in a state where ‘Starbucks Gangnam Station’ is included in the interest list, when the user goes to ‘Myeongdong Station’, the Starbucks branch around ‘Myeongdong Station’ may be displayed. For another example, in the case where ‘Mad for Garlic Gangnam Station’ being the Italian restaurant franchise is included in the interest list, when there is no ‘Mad for Garlic’ near the user, nearby Italian restaurants may be displayed.

According to certain embodiments, the processor 120 may display additional information by making a request for additional information to a server associated with the matched item. For example, when ‘Starbucks’ is the matched item, the processor 120 may query a ‘Starbucks’ parameter to the server of the partner company associated with ‘Starbucks’; as a result, the processor 120 may display the transmitted POI.

According to certain embodiments, the processor 120 may make a request for recommendation information to an external server, using information about the recognized surrounding building or store. The processor 120 may display the recommended item received from the external server together with items of the interest list.

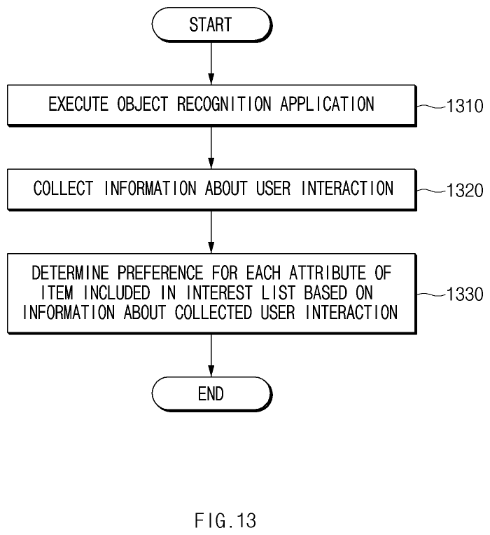

FIG. 13 is a flowchart illustrating storage of a user preference, according to certain embodiments.

Referring to FIG. 13, in operation 1310, the processor 120 may execute an object recognition application (e.g., Bixby vision, Google Lens, or Naver Smart Lens). The object recognition application may be an application that recognizes an object by using the camera module 180 and displays related information.

In operation 1320, the processor 120 may collect information about a user interaction that occurs while the object recognition application is executed. The interaction may include state information of the electronic device recognized through a user input or a sensor.

According to certain embodiments, the processor 120 may distinguish between user interactions occurring in each of various modes (e.g., a shopping mode, a wine recognition mode, and a home appliance and furniture virtual placement experience mode) of the object recognition application and may store the user interactions in the interaction DB 222.

For example, the processor 120 may collect information about the interaction of the specified user that occurs in each mode as illustrated in Table 1 below.

TABLE 1

| Mode | User interaction | Description |
|---|---|---|
| Shopping | Product view, product | |
| | purchase, or keyword search | |
| Book | Product view, or product | View detailed |
| | purchase | information via web |
| Wine | Product view, or product | View detailed |
| | purchase | information via web |
| Makeup | Product view, or product | |
| (Virtual | purchase | |
| experience) | | |
| Home appliances | Virtual view, virtual | Virtual view: Select/ |
| and furniture | placement confirmation, | place a product by AR |
| (Virtual | product view, or | Virtual placement |
| experience) | product purchase | confirmation: Finally |
| | | place and confirm a |
| | | product |
| Accessories | virtual view, color | |
| (Virtual | selection, product view, | |
| experience) | or product purchase | |
| Place | Place view, place sharing, | |
| | or map view | |

In operation 1330, the processor 120 may determine the preference for each attribute of an item included in the interest list based on information about the collected user interaction. The processor 120 may store the preference for the user's product in the preference DB 223. For example, when the number of searches, views, or purchases of a product is great, the processor 120 may highly set a preference for the attribute of the product.

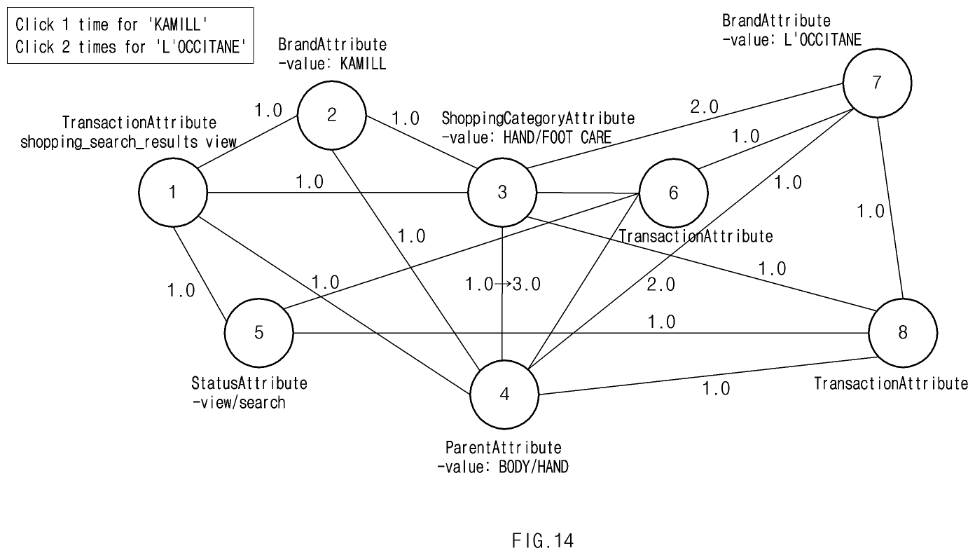

FIG. 14 illustrates graph generation for user preference analysis, according to certain embodiments. FIG. 14 is, but is not limited to, an example.

Referring to FIG. 14, the processor 120 may determine the preference for each attribute of an item included in an interest list, based on interaction data of a user. The processor 120 may store the preference for the user's product in a database. The processor 120 may analyze the number of searches, views, or purchases of a product to change the user's preference for the attribute of the corresponding product.

For example, the first to eighth nodes included in FIG. 14 may represent attribute values associated with a hand cream, respectively. The processor 120 may update the preference depending on the user interaction displayed on products of the brands “Kamill” and “L'Occitane”.

The number between nodes may indicate a weight according to the number of user interactions occurring between related nodes. For example, the number 2.0 between the third node and the fourth node may indicate that two user interactions have occurred in the hand/foot care (the third node) and brand L'Occitane (the seventh node) of a shopping category.

The fourth node (body/hand) may be an upper category of the third node (hand/foot care); the weight of 2.0 may be identically assigned between the fourth node and the seventh node.

When user interactions occur in both products “L'Occitane” and “Kamill”, the weight of each of the third node and the fourth node may be increased (increasing a category preference).

The first to fifth nodes may be nodes associated with “Kamill”. When the user clicks product “Kamill” once, the weights for the first to fifth nodes may be changed.

The third to eighth nodes may be nodes associated with “L'Occitane”. When the user double-clicks product “L'Occitane”, the weights for the sixth and eighth nodes may be changed.

In this case, between the third node and the fourth node, the weight of 2.0 by to the interaction occurring in “L'Occitane” may be added to the weight of 1.0 by the interaction occurring in existing “Kamill”, and thus the weight may be 3.0.

Two interactions for each category may occur between the fourth node and the seventh node, and between the third node and the seventh node, and thus the weight of 2.0 may be assigned.

The processor 120 may set a weight such that the weight of brand “L'Occitane” having the high number of searches, views, or purchases is higher than the weight of brand “Kamill” among the products of brands “Kamill” and “L'Occitane” in a hand/foot care category.

According to certain embodiments, an electronic device (e.g., the electronic device 101 of FIG. 1) may include a display (e.g., the display device 160 of FIG. 1), a memory (e.g., the memory 130 of FIG. 1) storing a list including at least one item in which a specified user is determined to have an interest, and a processor (e.g., the processor 120 of FIG. 1). The processor (e.g., the processor 120 of FIG. 1) may recognize an object in image data obtained through the camera (e.g., the camera module 180 of FIG. 1) or stored in the memory (e.g., the memory 130 of FIG. 1), may identify an attribute associated with the recognized object, may identify an item having an attribute, which is the same as or similar to the attribute, from among the at least one item included in the list, and may link information about the identified item with the image data to display the linked result on the display (e.g., the display device 160 of FIG. 1).

According to certain embodiments, the processor (e.g., the processor 120 of FIG. 1) may store the interest list in the memory (e.g., the memory 130 of FIG. 1) in conjunction with a first application associated with object recognition. The processor (e.g., the processor 120 of FIG. 1) may receive a product list managed by a second application associated with product purchase and may update the list.

According to certain embodiments, the memory (e.g., the memory 130 of FIG. 1) may store a database (e.g., the preference DB 223 of FIG. 2) that scores and manages a preference of a user associated with the item and an attribute of the item. The processor (e.g., the processor 120 of FIG. 1) may sort the identified item with reference to the database (e.g., the preference DB 223 of FIG. 2) to display the sorted item on the display (e.g., the display device 160 of FIG. 1).

According to certain embodiments, when a specified user interaction occurs in association with the item, the processor (e.g., the processor 120 of FIG. 1) may update the database (e.g., the preference DB 223 of FIG. 2) based on the user interaction.

According to certain embodiments, the processor (e.g., the processor 120 of FIG. 1) may transmit the image data to an external server and may receive recognition information about the object from the external server.

According to certain embodiments, the processor (e.g., the processor 120 of FIG. 1) may perform image processing on the image data to extract information about a contour, shape, or feature point of the object and may determine recognition information about the object based on the extracted information.

According to certain embodiments, the processor (e.g., the processor 120 of FIG. 1) may determine an item having a category the same as or similar to a first attribute of the recognized object. The processor (e.g., the processor 120 of FIG. 1) may sort an item having the first attribute based on a second attribute of the recognized object. When the item having the first attribute is equal to or greater than a specified number, the processor (e.g., the processor 120 of FIG. 1) may determine the item having the second attribute.

According to certain embodiments, the processor (e.g., the processor 120 of FIG. 1) may determine the item having an attribute the same as or similar to at least one of a first attribute or a second attribute of the recognized object.

According to certain embodiments, the processor (e.g., the processor 120 of FIG. 1) may determine the item having the recognized object as an attribute. The processor (e.g., the processor 120 of FIG. 1) may apply an image effect based on the determined item to the recognized object.

According to certain embodiments, the processor (e.g., the processor 120 of FIG. 1) may determine the item based on location information of the electronic device (e.g., the electronic device 101 of FIG. 1) or current date information.

According to certain embodiments, the processor (e.g., the processor 120 of FIG. 1) may display recommendation information associated with the recognized object or the attribute.

According to certain embodiments, the processor (e.g., the processor 120 of FIG. 1) may execute an application associated with the determined item based on an attribute of the item in a specified state.

According to certain embodiments, an object recognizing method performed by an electronic device (e.g., the electronic device 101 of FIG. 1) may include storing a list including at least one item in which a specified user is determined to have an interest, in a memory (e.g., the memory 130 of FIG. 1) of the electronic device (e.g., the electronic device 101 of FIG. 1), recognizing an object in image data obtained through a camera (e.g., the camera module 180 of FIG. 1) or the memory (e.g., the memory 130 of FIG. 1), identifying an attribute associated with the recognized object, identifying an item having an attribute, which is the same as or similar to the attribute, from among at least one item included in the list, and linking information about the identified item with the image data to display the linked result on a display (e.g., the display device 160 of FIG. 1).

According to certain embodiments, the storing of the list may include storing the list in conjunction with a first application associated with object recognition.

According to certain embodiments, the identifying of the item may include determining an item having a category the same as or similar to a first attribute of the recognized object.

According to certain embodiments, the identifying of the item may include determining the item having an attribute the same as or similar to at least one of a first attribute or a second attribute of the recognized object.

An electronic device according to certain embodiments of the present disclosure may be a device of various types. The electronic device according to certain embodiments of the present disclosure may include at least one of a smartphone, a tablet personal computer (PC), a mobile phone, a video telephone, an electronic book reader, a desktop PC, a laptop PC, a netbook computer, a workstation, a server, personal digital assistant (PDA), a portable multimedia player (PMP), a Motion Picture Experts Group (MPEG-1 or MPEG-2) Audio Layer 3 (MP3) player, a mobile medical device, a camera, or a wearable device. According to certain embodiments, a wearable device may include at least one of an accessory type of device (e.g., a timepiece, a ring, a bracelet, an anklet, a necklace, glasses, a contact lens, or a head-mounted device (HMD)), a one-piece fabric or clothes type of device (e.g., electronic clothes), a body-attached type of device (e.g., a skin pad or a tattoo), or a bio-implantable type of device (e.g., implantable circuit). According to certain embodiments, the electronic device may include at least one of, for example, televisions (TVs), digital versatile disk (DVD) players, audios, audio accessory devices (e.g., speakers, headphones, or headsets), refrigerators, air conditioners, cleaners, ovens, microwave ovens, washing machines, air cleaners, set-top boxes, home automation control panels, security control panels, game consoles, electronic dictionaries, electronic keys, camcorders, or electronic picture frames.

In another embodiment, the electronic device may include at least one of navigation devices, satellite navigation system (e.g., Global Navigation Satellite System (GNSS)), event data recorders (EDRs) (e.g., black box for a car, a ship, or a plane), vehicle infotainment devices (e.g., head-up display for vehicle), industrial or home robots, drones, automatic teller's machines (ATMs), points of sales (POSs), measuring instruments (e.g., water meters, electricity meters, or gas meters), or internet of things (e.g., light bulbs, sprinkler devices, fire alarms, thermostats, or street lamps). The electronic device according to an embodiment of this disclosure may not be limited to the above-described devices, and may provide functions of a plurality of devices like smartphones which has measurement function of personal biometric information (e.g., heart rate or blood glucose). In this disclosure, the term “user” may refer to a person who uses an electronic device or may refer to a device (e.g., an artificial intelligence electronic device) that uses the electronic device.

The electronic device according to certain embodiments disclosed in the disclosure may be various types of devices. The electronic device may include, for example, a portable communication device (e.g., a smartphone), a computer device, a portable multimedia device, a mobile medical appliance, a camera, a wearable device, or a home appliance. The electronic device according to an embodiment of the disclosure should not be limited to the above-mentioned devices.

It should be understood that certain embodiments of the disclosure and terms used in the embodiments do not intend to limit technical features disclosed in the disclosure to the particular embodiment disclosed herein; rather, the disclosure should be construed to cover various modifications, equivalents, or alternatives of embodiments of the disclosure. With regard to description of drawings, similar or related components may be assigned with similar reference numerals. As used herein, singular forms of noun corresponding to an item may include one or more items unless the context clearly indicates otherwise. In the disclosure disclosed herein, each of the expressions “A or B”, “at least one of A and B”, “at least one of A or B”, “A, B, or C”, “one or more of A, B, and C”, or “one or more of A, B, or C”, and the like used herein may include any and all combinations of one or more of the associated listed items. The expressions, such as “a first”, “a second”, “the first”, or “the second”, may be used merely for the purpose of distinguishing a component from the other components, but do not limit the corresponding components in other aspect (e.g., the importance or the order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

The term “module” used in the disclosure may include a unit implemented in hardware, software, or firmware and may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, according to an embodiment, the “module” may include an application-specific integrated circuit (ASIC).

Certain embodiments of the disclosure may be implemented by software (e.g., the program 140) including an instruction stored in a machine-readable storage medium (e.g., an internal memory 136 or an external memory 138) readable by a machine (e.g., the electronic device 101). For example, the processor (e.g., the processor 120) of a machine (e.g., the electronic device 101) may call the instruction from the machine-readable storage medium and execute the instructions thus called. This means that the machine may perform at least one function based on the called at least one instruction. The one or more instructions may include a code generated by a compiler or executable by an interpreter. The machine-readable storage medium may be provided in the form of non-transitory storage medium. Here, the term “non-transitory”, as used herein, means that the storage medium is tangible, but does not include a signal (e.g., an electromagnetic wave). The term “non-transitory” does not differentiate a case where the data is permanently stored in the storage medium from a case where the data is temporally stored in the storage medium.

According to an embodiment, the method according to certain embodiments disclosed in the disclosure may be provided as a part of a computer program product. The computer program product may be traded between a seller and a buyer as a product. The computer program product may be distributed in the form of machine-readable storage medium (e.g., a compact disc read only memory (CD-ROM)) or may be directly distributed (e.g., download or upload) online through an application store (e.g., a Play Store™) or between two user devices (e.g., the smartphones). In the case of online distribution, at least a portion of the computer program product may be temporarily stored or generated in a machine-readable storage medium such as a memory of a manufacturer's server, an application store's server, or a relay server.

According to certain embodiments, each component (e.g., the module or the program) of the above-described components may include one or plural entities. According to certain embodiments, at least one or more components of the above components or operations may be omitted, or one or more components or operations may be added. Alternatively or additionally, some components (e.g., the module or the program) may be integrated in one component. In this case, the integrated component may perform the same or similar functions performed by each corresponding components prior to the integration. According to certain embodiments, operations performed by a module, a programming, or other components may be executed sequentially, in parallel, repeatedly, or in a heuristic method, or at least some operations may be executed in different sequences, omitted, or other operations may be added.

According to certain embodiments disclosed in this specification, while executing an object recognition application, an electronic device may display, in real time, a product having attributes the same as or similar to those of the recognized object, in a user's interest list.

According to certain embodiments disclosed in this specification, an electronic device may provide, in real time, information about a product included in the user's interest list or a place in which the user has an interest, thereby increasing the user's accessibility to the product and increasing the sales of the product.

According to certain embodiments disclosed in this specification, the electronic device may manage the user's preference associated with the recognized object through a database and may display the products in the user's interest list on the screen in order of the high interest of a user.

While the disclosure has been shown and described with reference to certain embodiments thereof, it will be understood by those skilled in the art that various changes in form and details may be made therein without departing from the disclosure as defined by the appended claims and their equivalents.

What is claimed is:

1. An electronic device, comprising:
a camera;
a display;
a memory storing instructions and a list, the list including one or more items designated by a user; and
a processor, operatively coupled to the camera, the display and the memory,
wherein instructions are executable by the processor to cause the electronic device to:
recognize an object included in an image captured using the camera or previously stored in the memory;
identify a first attribute associated with the recognized object;
identify a matching item, from among the list, that has the first attribute; and
associate information for the identified matching item with the captured image and display the associated information on the display.

2. The electronic device of claim 1, wherein the list is stored in association with a first application that includes an object recognition function.

3. The electronic device of claim 2, wherein the instructions are executable by the processor to cause the electronic device to:
receive a product list managed by a second application associated with a product purchase function; and
update the list including the one or more items based in part on the received product list.

4. The electronic device of claim 1, wherein a database is stored in the memory, the database storing scores of user preferences associated with each of the one or more items, and attributes of each of the one or more items, and
wherein the instructions are executable by the processor to cause the electronic device to:
detect multiple matched items having the first attribute and display the multiple matched items on the display,
wherein the multiple matched items are sorted into an arrangement for display by reference to information stored in the database.

5. The electronic device of claim 4, wherein the instructions are executable by the processor to cause the electronic device to:
in response to detecting a prespecified user input associated with the item, update the database according to the prespecified user input.

6. The electronic device of claim 1, wherein recognizing the object included in the image further comprises:
transmitting the captured image to an external server; and
receive recognition information for the object from the external server.

7. The electronic device of claim 1, wherein recognizing the object included in the image further comprises:
executing image processing on the captured image to extract information including at least one of a contour, shape, or feature point of the object; and
generate recognition information for the object based on the extracted information.

8. The electronic device of claim 1, wherein the matching item is identified when a first prespecified category of the matching item matches a second prespecified category of the recognized object.

9. The electronic device of claim 1, wherein when multiple matched items having the first attribute are detected, the identified matching item is sorted among the multiple matched items based on a second attribute of the recognized object, different from the first attribute matching the identified attribute.

10. The electronic device of claim 9, wherein the instructions are executable by the processor to cause the electronic device to:
when a count of the multiple matched items is greater than or equal to a prespecified count, the matching item is identified from among the list using the second attribute, in addition to the first attribute.

11. The electronic device of claim 1, wherein the matching item is identified when the matching item has a second attribute or a third attribute of the recognized object.

12. The electronic device of claim 1, wherein the first attribute is a name of the recognized object.

13. The electronic device of claim 12, wherein the instructions are executable by the processor to cause the electronic device to:
apply a visual effect to the recognized object on the display after identifying the matching item.

14. The electronic device of claim 1, wherein the first attribute used to identify the matching item includes one of a current location of the electronic device and a current date.

15. The electronic device of claim 1, wherein the instructions are executable by the processor to cause the electronic device to:
display recommendation information that is associated with the recognized object or associated with the first attribute.

16. The electronic device of claim 1, wherein the instructions are executable by the processor to cause the electronic device to:
execute an application that is associated with the identified matching item, based at least in part on the first attribute.

17. A method for an electronic device, the method comprising:
storing a list including at least one or more items designated by a user in a memory of the electronic device;
recognizing an object included in an image captured using a camera or previously the memory;
identifying a first attribute associated with the recognized object;
identifying a matching item, from among the list, that has the first attribute; and
associating information for the identified matching item with the captured image and displaying the associated information on a display.

18. The method of claim 17, wherein the list is stored in association with a first application that includes an object recognition function.

19. The method of claim 17, wherein the matching item is identified when a first prespecified category of the matching item matches a second prespecified category of the recognized object.

20. The method of claim 17, wherein the matching item is identified when the matching item has a second attribute or a third attribute of the recognized object.
